(19) United States
(12) Patent Application Publication
(10) Pub. No.: US 2025/0347389 A1
(43) Pub. Date: Nov. 13, 2025

(54) COVERS FOR CONTAINERS, REGULATORS, FAUCETS, PIPES, AND VALVES USED IN HOT AND COLD ENVIRONMENTS

(71) Applicant: Layli Mohtashami, Mesa, AZ (US)

(72) Inventor: Layli Mohtashami, Mesa, AZ (US)

(21) Appl. No.: 18/656,639

(22) Filed: May 7, 2024

(51) Int. Cl. F17C 13/12; B32B 5/18; B32B 27/06; B32B 27/28

(52) U.S. Cl. CPC F17C 13/12; B32B 5/18; B32B 27/065; B32B 27/283; B32B 2266/126; B32B 2307/304; B32B 2307/3065; B32B 2307/7265; B32B 2571/00; F17C 2203/0325; F17C 2221/035; F17C 2260/042; F17C 2270/0745

(57) ABSTRACT

A cover provides fireproofing and prevents overheating of a container having combustible content in hot environments. The container may be a tank. The regulator cover provides fireproofing and prevents overheating of a tank regulator in hot environments and prevents freezing of a tank regulator in cold environments.

### FIELD OF INVENTION

The invention relates to safety devices and, more specifically, to an apparatuses for protecting pipes, faucets, valves, tanks and tank regulators.

### BACKGROUND

In current practice, the way to prevent a container or a tank from exploding in temperatures that exceed 110 degrees Fahrenheit is to unhook it from the appliance it is connected to and put it in the shade. In the extreme summer heat of desert climates around the world, air temperatures can routinely reach over 115 degrees Fahrenheit during the summer months. With global warming becoming a reality these summer temperatures will most likely increase over time. Extremely hot weather puts containers/tanks in danger of exploding with possible adverse consequences such as killing and maiming people, destroying recreational vehicles and travel trailers, and setting fire to homes whose residents use barbeque grills.

If a pipe, a faucet, or a container/tank, including the tank regulator and/or valve, is exposed to a fire in or near a home, or while being used in a camping setting, or an industrial or military application it can result in failure or explode exposing nearby people and property to injury, death and/or damage.

Currently, in climates that are cold during the winter, pipes, faucets, and tank regulators do not have covers that both insulate while offering fire protection. If a fire occurs near a tank regulator, the unprotected regulator can become the conduit for fire to reach and ignite the connected tank causing a substantial explosion, again exposing people and property to injury, death and/or damage.

What is needed is an apparatus that will keep tanks and tank regulators cool during the extreme heat of summer in desert climates, other high temperature environments and fire; and that will insulate and offer fire protection to tank regulators in cold winter climates.

### SUMMARY OF THE INVENTION

The present invention prevents pipes, valves, faucets, containers (such as tanks), and regulators from overheating and exploding during extremely hot summer weather, when exposed to fire and other hot environments; and of protecting containers from exploding when exposed to fire. The present invention also protects pipes, valves, faucets, tanks, and tank regulators from dropping below freezing in cold environments, so that any moisture potentially collecting in the pipes, valves, faucets, containers/tanks, or regulators' vent hole does not freeze and plug up the vent hole, causing pressure buildup and impairing the functioning of the pipes, valves, faucets, tanks, or tank regulators.

The present invention provides an apparatus for wrapping pipes, faucets, tanks, valves, and tank regulators in a one-piece layered blanket-like cover that provides protection from extremely hot weather, a nearby fire. Another iteration of the invention provides fire protection for pipes, valves, faucets, tanks, and tank regulators in cold climates.

For cooling of pipes, faucets, valves, tanks, and tank regulators in extremely hot climates, a one-piece layered blanket includes: an inner layer composed of an insulating core surrounded by a durable cover that provides insulation and fire protection; a middle layer that provides additional protection from excess heat and fire; and a moisture barrier that protects the inner layer from rough handling. The outermost layer acts as a reflective shield that repulses radiant heat energy from the sun.

### BRIEF DESCRIPTION OF THE DRAWINGS

Various embodiments will be better understood from a reading of the following detailed description taken in conjunction with the drawings in which like reference designators are used to designate like elements, and in which:

FIG. 1 illustrates the outer surface of a one-piece layered cover for tanks in accordance with various aspects and embodiments of the invention.

FIG. 2 illustrates an inner surface of the one-piece layered cover for tanks in accordance with various aspects and embodiments of the invention.

FIG. 3 Illustrates the outer surface of a one-piece layered cover for tank regulators in accordance with various aspects and embodiments of the invention.

FIG. 4 illustrates the inner surface of the one-piece layered cover for tank regulators in accordance with various aspects and embodiments of the invention.

FIG. 5 illustrates a cross-section of the one-piece layered protective cover for tanks and tank regulators, which are in extremely hot and cold environments, in accordance with various aspects and embodiments of the invention.

FIG. 6 illustrates a tank being wrapped in the one-piece layered tank cover in accordance with various aspects and embodiments of the invention.

FIG. 7 illustrates a tank regulator being wrapped in the one-piece layered tank regulator cover in accordance with various aspects and embodiments of the invention.

### DETAILED DESCRIPTION

To the extent that the terms “including”, “includes”, “having”, “has”, “with”, or variants thereof are used in either the detailed description and the claims, such terms are intended to be inclusive in a similar manner to the term “comprising”. The invention is described in accordance with the aspects and embodiments in the following description with reference to the figures, in which like numbers represent the same or similar elements. Reference throughout this specification to “one embodiment,” “an embodiment,” or similar language means that a particular feature, structure, or characteristic described in connection with the various aspects and embodiments are included in at least one embodiment of the invention. Thus, appearances of the phrases “in one embodiment,” “in an embodiment,” “in certain embodiments,” “in some embodiments,” and similar language throughout this specification refer to the various aspects and embodiments of the invention. It is noted that, as used in this description, the singular forms “a,” “an” and “the” include plural referents, unless the context clearly dictates otherwise.

The described features, structures, or characteristics of the invention may be combined in any suitable manner in accordance with the aspects and one or more embodiments of the invention. In the following description, numerous specific details are recited to provide an understanding of various embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring the aspects of the invention.

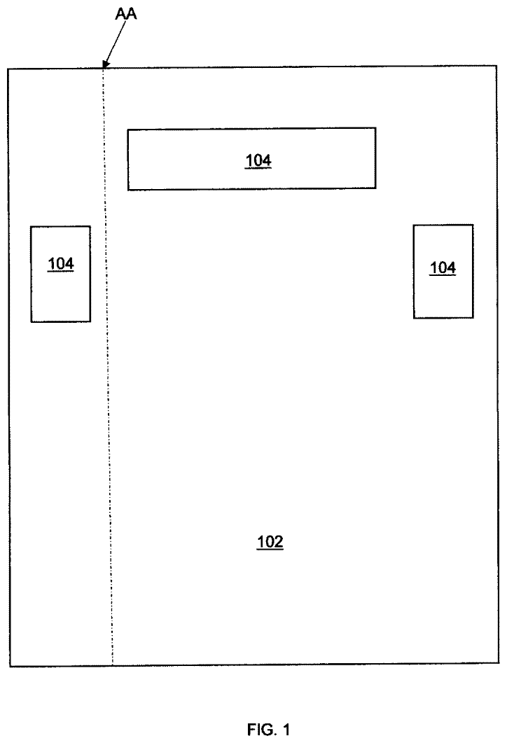

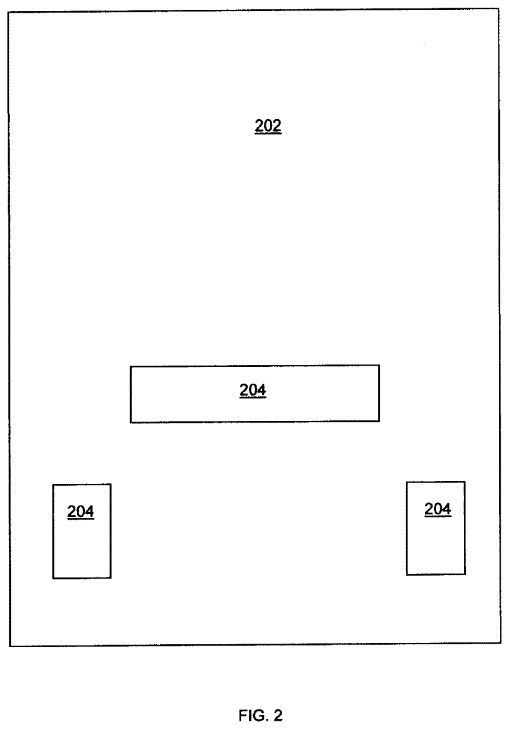

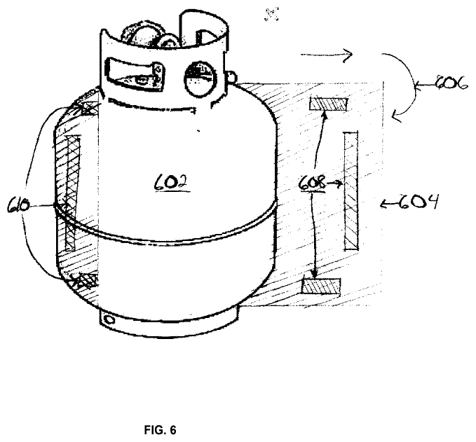

Now referring to FIG. 1, FIG. 2 and FIG. 6, according with various aspects and embodiments of the invention, shown is the outward facing surface (once installed around a tank or in other embodiments around pipes, valves, faucets that are referred to herein as control devices) of a one-piece layered blanket-like cover 102, 202, 604 that covers a tank 602 for use in environments with extreme temperatures, such as greater than one-hundred-ten (110) degrees Fahrenheit or below thirty-two (32) degrees Fahrenheit. In accordance with the various embodiment of the invention, the tank is a propane tank. The scope of the invention is not limited by the type of pipes, valves, faucets, tank (or the type of compound or substance or gas stored in the tank or moving through the pipes, valves, faucets). In accordance with one embodiment of the invention, three hooked Velcro strips 104, 610 are shown populating end of the cover 102, 604 and three looped Velcro strips 204 are shown populating an opposite side of (the other end of) the same cover 202, 604 In accordance with other embodiments, a male-female fastener is used. In accordance with some embodiments, a buckle and strap fastener is used. The scope of the invention is not limited by the type of fastener used.

The one-piece layered blanket-like cover 102, 202, 604 is wrapped around the tank 602 beginning at the edge of the cover 102, 604 that contains the hooked Velcro strips 104, 610 with the hooked Velcro strips 104, 610 facing outward-away from the tank 602. In accordance with some embodiment the cover 102, 202, 604 is wrapped around pipes, valves, faucets, or other structures in a similar manner. Once the blanket-like cover 102, 202, 604 is fully wrapped around the tank 602, the looped Velcro strips 204, 608 will be facing inward, toward the tank 602 and opposite the hooked Velcro strips 102, 610. The looped Velcro strips 204, 608 on the inner surface of the cover will then be compressed against the hooked Velcro strips 104, 610 that are located on the opposite end of the outer surface of the one-piece layered blanket-like tank cover 102, 202, 604. Once the hooked Velcro strips 104, 610 and looped Velcro strips 204, 608 are attached to one another, the one-piece layered blanket-like tank cover 102, 202, 604 will be securely wrapped around the tank 602.

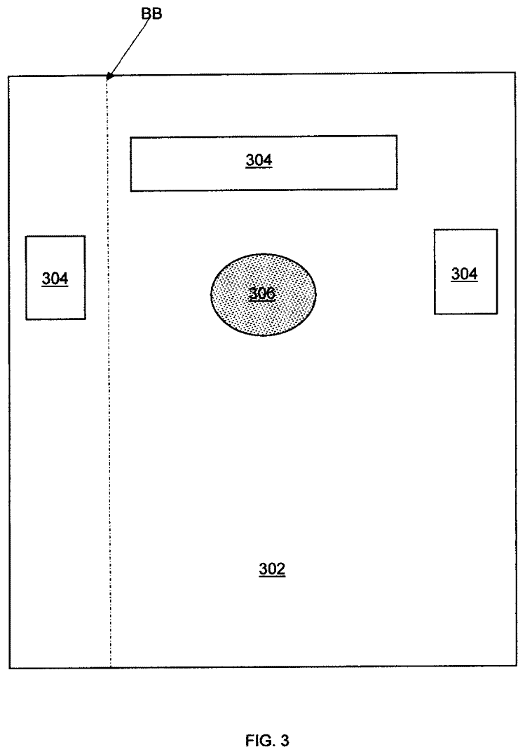

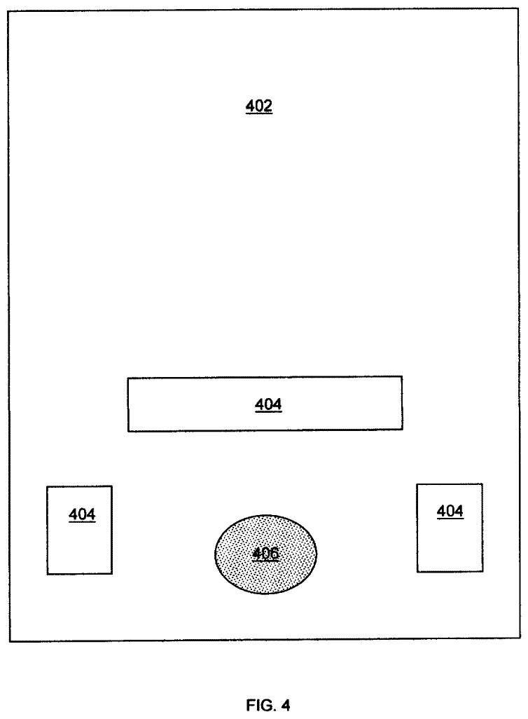

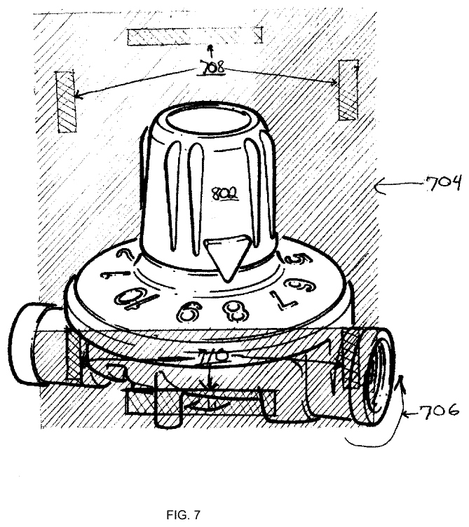

Now referring to FIG. 3, FIG. 4 and FIG. 7 according to various aspects and embodiments of the invention, FIG. 3 illustrates the outward facing surface (once wrapped around a tank regulator 702) of a one-piece layered blanket-like tank regulator cover 302, 402, 704 for use in extremely hot environments and in cold environments with temperatures lower than thirty-two degrees Fahrenheit. In accordance with one embodiment of the invention, three hooked Velcro hook strips 304, 710 are shown populating one end of the cover 302, 402, 704. In accordance with other embodiments, a male-female fastener is used. In accordance with some embodiments, a buckle and strap fastener is used. The scope of the invention is not limited by the type of fastener used.

The one-piece layered blanket-like tank regulator cover 302, 402, 704 is wrapped unto the tank regulator 702 beginning at the end of the cover with the hooked Velcro strips 304, 710. The hooked Velcro strips 304, 710 will be facing outward, away from the tank regulator 702, when the tank regulator 702 is being wrapped. Once the one-piece layered blanket-like tank regulator cover is fully wrapped, the inward facing looped Velcro strips 404, 708 on the opposite end of other side of the cover 302, 402, 704 will then be compressed against the outward facing hooked Velcro strips 304, 710 located on the opposite end on the outward facing surface of the tank regulator cover 302, 02, 704 r Once the hooked Velcro strips 304, 710 and the looped Velcro strips 404, 708 are attached to one another, the tank regulator cover 302, 402, 704 will be securely wrapped around the tank regulator 702.

Referring again to FIG. 3 and FIG. 4, directional indicator mark 306 and 406 is a symbol visible on both the outward facing surface (when wrapped) of the tank regulator cover 302 and the inward facing surface (when wrapped) of the tank regulator cover 402. The directional indicators 306 and 406 are located near the hooked Velcro strips 304 on the outward facing surface of the cover 302 and located near the looped Velcro strips 404 on the inward facing surface 402 of the cover. The directional indicators 306 and 406 show the downward direction to which the regulator vent hole should be directed. The directional indicator 306 shows the downward direction that the regulator vent hole should be oriented when the regulator cover is being wrapped, and the directional indicator 406 shows the same downward direction that the regulator vent hole should be oriented when the tank regulator is fully wrapped. Regulator vent holes should be directed in a downward direction to prevent water collecting and freezing in the vent hole, potentially blocking the flow of propane in cold weather.

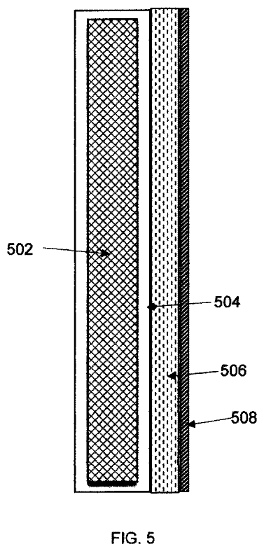

Now referring to FIG. 5, FIG. 1, and FIG. 3, according to various aspects and embodiments of the invention, shown is a cross-sectional view taken along the line AA of FIG. 1 and along the line BB of FIG. 3 for a one-piece layered tank cover and the edge of a one-piece layered tank regulator cover, respectively, for use in high temperature and below freezing environments. The innermost layer 502 (when wrapped) is composed of an aerogel compound (such as Pyrogel XTFR), which is encased within a second layer, a durable/flexible enclosure 504. Adhered to the enclosure 504 is a layer 506. In accordance with some embodiments, the layer 506 includes an insulating, fireproofing and water-proofing substance/material such fire-retardant impregnated silicone. In accordance with some embodiments, the layer 506 includes an insulating substance/material. In accordance with some embodiments, the layer 506 includes a fireproofing substance/material, such as a fire-retardant impregnated silicone. In accordance with some embodiments, the layer 506 includes a water-proofing substance/material. In accordance with some embodiments, the layer 506 includes any combination of an insulating, fireproofing and water-proofing substance/material.

The inner aerogel layer completely insulates the tank 602 and/or tank regulator 702 in hot environments including fire and in freezing environments, while also providing moisture resistance. The layer 506 protects the aerogel layer from damage caused by potential rough handling, and provides additional waterproofing, insulation, and fireproofing. Adhered to the layer 506 is a reflective layer 508. The reflective layer 508 reflects radiant energy, such as the light/heat of the sun in extremely hot environments (or extreme cold environments) away from the tank 602 and away from the tank regulator 702; this helps to prevent heat buildup inside the tank 602 and inside the tank regulator 702 as well as freezing due to extreme cold temperatures.

In accordance with some embodiments of the invention, the one-piece layered blanket-like tank regulator cover and the one-piece layered blanket-like tank regulator cover include the same layers and are made of the same substances. In accordance with some embodiments of the invention, the one-piece layered blanket-like tank regulator cover and the one-piece layered blanket-like tank regulator cover include variances in the number of layers or type of substances that make up each layer.

Now referring to FIG. 6, FIG. 1, and FIG. 2, according to various aspects and embodiments of the invention, shown is a tank 602 being wrapped by a one-piece layered blanket-like tank cover 102, 202. In accordance with some aspects and embodiments of the invention, the cover 102, 202 is wrapped around pipes, valves, and faucets as noted and in a similar manner. The tank cover 604 is wrapped around the tank 602 from edge of the cover 604 that is populated by three hooked Velcro strips 610 facing outward. The cover is then wrapped around the body of the tank 602 until the other three looped Velcro strips 608 on the opposite side of the opposite end of the cover meet. The Velcro strip are pressed together and the cover 604 is secured around the tank 602.

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the invention is not entitled to antedate such publication by virtue of prior invention. Further, the dates of publication provided may be different from the actual publication dates which may need to be independently confirmed.

Additionally, it is intended that such equivalents include both currently known equivalents and equivalents developed in the future, i.e., any elements developed that perform the same function, regardless of structure. The scope of the invention, therefore, is not intended to be limited to the exemplary embodiments shown and described herein.

Accordingly, the preceding merely illustrates the various aspects and principles as incorporated in various embodiments of the invention. It will be appreciated that those of ordinary skill in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

Therefore, the scope of the invention is not intended to be limited to the various aspects and embodiments discussed and described herein. Rather, the scope and spirit of invention is embodied by the appended claims.

What is claimed is:

1. An apparatus for protecting a tank, the apparatus comprising:
a one-piece layered cover for the tank, including:
an inner layer for insulating the tank, wherein the inner layer includes aerogel compound;
a middle layer secured to the inner layer for insulating and fireproofing the tank; and
an outer layer secured to the middle layer for deflecting radiant energy; and
a fastener, wherein the fastener secures the apparatus around the tank,
wherein a first portion of the fastener is attached to the inner layer of the cover and a second portion of the fastener is attached to the outer layer of the cover.

2. The apparatus of claim 1 further comprising a one-piece regulator cover for protecting a regulator, wherein the one-piece regulator cover is connected to the one-piece layered cover for the tank.

3. The apparatus of claim 2, wherein the regulator cover comprises:
a second inner layer for insulating the regulator cover, wherein the second inner layer includes aerogel compound;
a second middle layer for waterproofing and fireproofing the regulator; and
a second outer layer for deflecting radiant energy.

4. The apparatus of claim 3 further comprising:
a symbol on the second inner layer that indicates direction for a vent hole orientation of the regulator; and
a second symbol on the second outer layer that indicates direction for the vent hole orientation.

5. The apparatus of claim 1, wherein the tank contains propane.

6. The apparatus of claim 1, wherein the fastener includes a hook portion as the first portion and a loop portion as the second portion.

7. The apparatus of claim 1, wherein the fastener includes a male portion as the first portion and a female portion as the second portion, such that the male portion and the female portion engage each other.

8. The apparatus of claim 1, wherein the fastener includes a buckle as the first portion and a strap as the second portion.

9. An apparatus for protecting a tank, the apparatus comprising:
a one-piece layered cover for the tank, including:
an inner layer for insulating the tank, wherein the inner layer includes aerogel compound; and
an outer layer secured to the inner layer for fireproofing and waterproofing and deflecting radiant energy; and
a fastener, wherein the fastener secures the apparatus around the tank,
wherein a first portion of the fastener is attached to the inner layer and a second portion of the fastener is attached to the outer layer.

10. The apparatus of claim 9, wherein the fastener's first portion is a hook portion of a hook-loop fastener and the fastener's second portion is a loop portion of the hook-loop fastener.

11. The apparatus of claim 9, wherein the fastener includes a male portion as the first portion and a female portion as the second portion, such that the male portion and the female portion engage each other.

12. The apparatus of claim 9, wherein the fastener includes a buckle as the first portion and a strap as the second portion.

13. A blanket for protecting a control device, the blanket comprising:
a one-piece layered cover including:
an inner layer for insulating the control device, wherein the inner layer includes aerogel compound; and
an outer layer secured to the inner layer for fireproofing and waterproofing; and
a fastener, wherein the fastener secures the blanket around the control device,
wherein a first portion of the fastener is attached to the inner layer and a second portion of the fastener is attached to the outer layer, such that when the blanket is wrapped around the control device, the fastener's first portion engages the fastener's second portion to hold the blanket in position about the control device.

14. The blanket of claim 13, wherein the fastener includes a hook portion as the first portion and a loop portion as the second portion.

15. The blanket of claim 13, wherein the fastener includes a male portion as the first portion and a female portion as the second portion, such that the male portion and the female portion engage each other.

16. The blanket of claim 13, wherein the fastener includes a buckle as the first portion that receives a strap as the second portion.

17. The blanket of claim 13, wherein the control device is a tank regulator.

18. The blanket of claim 13, wherein the control device is a valve.

19. The blanket of claim 13, wherein the control device is a faucet.
